(19) United States
(12) Patent Application Publication
(10) Pub. No.: US 2014/0293825 A1
(43) Pub. Date: Oct. 2, 2014

(54) TIMESTAMPING DATA PACKETS

(71) Applicant: BROADCOM CORPORATION, Irvine, CA (US)

(72) Inventors: Mohan Kalkunte, Saratoga, CA (US); Puneet Agarwal, Cupertino, CA (US); Shahram Davari, Los Altos, CA (US)

(21) Appl. No.: 13/912,973

(22) Filed: Jun. 7, 2013

Related U.S. Application Data
(60) Provisional application No. 61/805,759, filed on Mar. 27, 2013.

(51) Int. Cl. H04L 12/26; H04L 29/06

(52) U.S. Cl. CPC H04L 43/0888; H04L 69/22
USPC 370/253; 370/474

(57) ABSTRACT

Disclosed are various embodiments for providing a data packet with timestamp information. A data packet is generated such that it comprises a payload and a header. The payload comprises a first timestamp field that comprises data indicating when a network device processed the data packet. The payload also comprises a body data field and a body data protocol field. The body data protocol field comprises data identifying a protocol used by body data in the body data field. The header comprises a payload protocol field that comprises data identifying that the payload comprises timestamp data.

### CROSS-REFERENCE TO RELATED APPLICATIONS

This application claims priority to co-pending U.S. Provisional Application Ser. No. 61/805,759, filed Mar. 7, 2013, which is hereby incorporated by reference herein in its entirety.

### BACKGROUND

In a networked environment, a source device transmits data packets to a destination device via a network. The network may comprise multiple switches that route and transmit the data packets through the network. For example, the source device can transmit a data packet to a network ingress switch. The network ingress switch may then transmit the data packet through the network using one or more of the other switches in the network. Thereafter, a network egress switch can provide the data packet to the destination device.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of an example of a networked environment according to various embodiments of the present disclosure.

FIGS. 2-4 are drawings of examples of data packets used in the networked environment of FIG. 1 according to various embodiments of the present disclosure.

FIG. 5 is a flowchart illustrating an example of functionality implemented by source device processing circuitry in the networked environment of FIG. 1 according to various embodiments of the present disclosure.

FIGS. 6A-6B are a flowchart illustrating an example of functionality implemented by ingress switch processing circuitry in the networked environment of FIG. 1 according to various embodiments of the present disclosure.

FIG. 7 is a flowchart illustrating an example of functionality implemented by transit switch processing circuitry in the networked environment of FIG. 1 according to various embodiments of the present disclosure.

FIGS. 8A-8B are a flowchart illustrating an example of functionality implemented by egress switch processing circuitry in the networked environment of FIG. 1 according to various embodiments of the present disclosure.

FIG. 9 is a flowchart illustrating an example of functionality implemented by destination device processing circuitry in the networked environment of FIG. 1 according to various embodiments of the present disclosure.

FIG. 10 is a flowchart illustrating an example of functionality implemented by administrator device processing circuitry in the networked environment of FIG. 1 according to various embodiments of the present disclosure.

### DETAILED DESCRIPTION

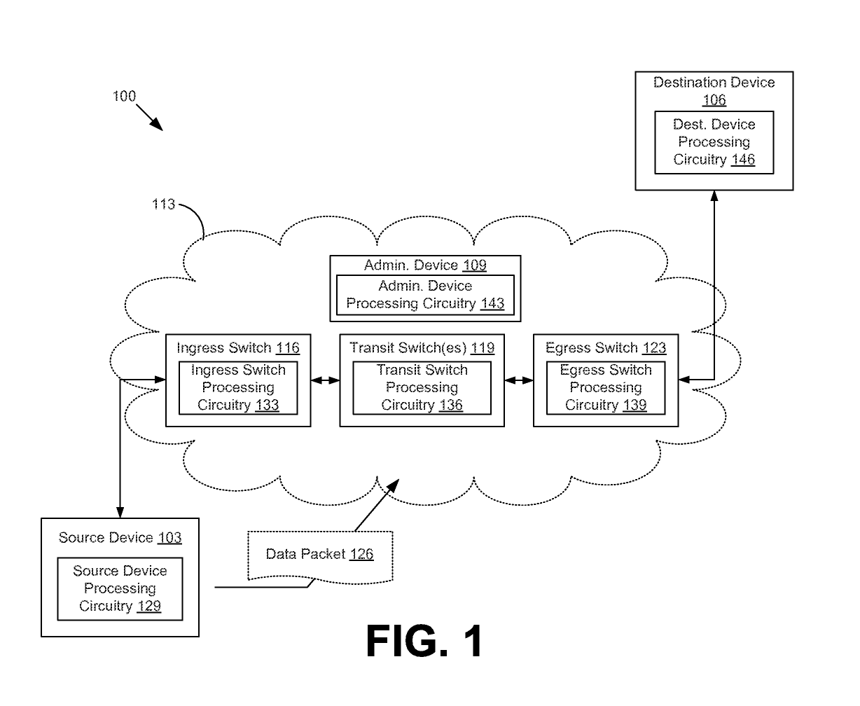

The present disclosure relates to timestamping data packets in a networked environment. With reference to FIG. 1, shown is an example of a networked environment 100 according to various embodiments of the present disclosure. Such a networked environment 100 may comprise, for example, a datacenter, such as an enterprise datacenter, a high performance computing datacenter, or any other type of networked computing environment. The networked environment 100 includes multiple network devices. For example, the embodiment shown in FIG. 1 includes a source device 103, a destination device 106, an administrator device 109, and multiple switches.

The switches and the administrator device 109 in the embodiment shown in FIG. 1 form a network 113. In particular, the network 113 in the embodiment shown in FIG. 1 comprises the administrator device 109, an ingress switch 116, one or more transit switches 119, an egress switch 123, and/or potentially other network devices. The network 113 is operable to facilitate data communication between the source device 103, the destination device 106, and/or potentially other network devices.

The source device 103 is representative of multiple source devices 103 that may be in communication with the network 113. According to various embodiments, the source device 103 may comprise a processor-based system, such as a server computer or any other suitable computing device. The source device 103 is operable to transmit and receive data to and from the destination device 106 and/or other devices using the network 113. To this end, the source device 103 comprises source device processing circuitry 129 and potentially other components and/or functionality. The source device processing circuitry 129 may, for example, generate data, format data, transmit data, and/or perform other processing functionality. As such, the source device processing circuitry 129 may comprise, for example, a network interface card (NIC) and/or other types of components.

The source device 103 generates and transmits data packets 126 to the destination device 106 and/or other devices using the network 113. The destination device 106 and potentially other devices may generate data packets 126 as well. A data packet 126 can comprise framed data that is suitable for transmission in the network 113. The data packet 126 may comprise control data and payload data. The control data can be located in a header portion and a footer portion of the data packet 126, and may facilitate the routing and transmission of the payload data in the data packet 126. The data packet 126 may also comprise timestamp data and/or body data that is located, for example, in the payload portion of the data packet 126.

According to various embodiments, a data packet 126 may comprise various fields. A field may be a portion of the data packet 126 that is reserved for a particular type of data. For example, various embodiments of a data packet 126 may comprise a destination address field, a source address field, one or more Virtual Local Area Network (VLAN) tag fields, a payload protocol field, a body data field, a Frame Check Sequence (FCS) field, and/or potentially other fields. The destination address field is designated for data representing the destination of the data packet 126. The source address field is designated for data representing the source of the data packet 126. The VLAN tag fields are designated for data representing VLANs to which the data packet 126 is associated. The payload protocol field is designated for data identifying the protocol used by the payload in the data packet 126. Such a payload protocol field may also be referred to as the “EtherType” field. The body data field is designated for the data generated by the source device 103 or another device and that is the purpose of the transmission of the data packet 126. The FCS field is designated for data representing the FCS used for error detection.

In alternative embodiments, a data packet 126 may comprise a destination address field, a source address field, Virtual Local Area Network (VLAN) tag fields, a payload protocol field, a timestamp format field, one or more timestamp fields, one or more device identification fields, a body data protocol field, a body data field, a Frame Check Sequence (FCS) field, and/or potentially other fields. A timestamp field is designated for data representing a timestamp. The timestamp format field is designated for data that specifies the format used to express the time data provided in the one or more timestamp fields. A device identification field is designated for data identifying the network device that provided a timestamp. The body data protocol field is designated for data indicating the format used for the body data within the payload of the data packet 126

The ingress switch 116 is representative of multiple ingress switches 116 that may be present in the network 113. The ingress switch 116 is a point of entry for a data packet 126 in the network 113. In this regard, the ingress switch 116 is the first switch in the network 113 that a data packet 126 encounters after being transmitted by the source device 103.

The ingress switch 116 routes and transfers the data packets 126 within the network 113. To this end, the ingress switch 116 comprises ingress switch processing circuitry 133 and potentially other components and/or functionality. The ingress switch processing circuitry 133 is operable to receive a data packet 126 from the source device 103, process the data packet 126, and route and transmit the data packet 126 in the network 113. According to various embodiments, the ingress switch processing circuitry 133 may also be operable to provide data packets 126 with timestamp data, as will be discussed below.

The transit switch 119 is representative of multiple transit switches 119 that may be present in the network 113. The transit switch 119 is a switch that is not an entry point or an exit point for a data packet 126 in the network 113. As such, the transit switch 119 is not the first or the last switch that receives or transmits a data packet 126 in the network 113.

The transit switch 119 routes and transfers the data packets 126 within the network 113. To this end, the transit switch 119 comprises transit switch processing circuitry 136 and potentially other components and/or functionality. The transit switch processing circuitry 136 is operable to receive a data packet 126 from the ingress switch 116 or another transit switch 119, process the data packet 126, and route and transmit the data packet 126 in the network 113. According to various embodiments, the transit switch processing circuitry 136 may also be operable to provide data packets 126 with timestamp data, as will be discussed below.

The egress switch 123 is representative of multiple egress switches 123 that may be present in the network 113. The egress switch 123 is a point of exit for a data packet 126 in the network 113. In this regard, the egress switch 123 is the last switch in the network 113 that a data packet 126 encounters before being received by the destination device 106.

The egress switch 123 routes and transfers the data packets 126 within the network 113. To this end, the transit switch 119 comprises egress switch processing circuitry 139 and potentially other components and/or functionality. The egress switch processing circuitry 139 is operable to receive a data packet 126 from the transit switch 119 or the ingress switch 116, process the data packet 126, and route and transmit the data packet 126 to the destination device 106. According to various embodiments, the egress switch processing circuitry 139 may also be operable to provide data packets 126 with timestamp data, as will be discussed below.

The administrator device 109 is operable to monitor and/or control various attributes of the network 113. To this end, the administrator device 109 comprises administrator device processing circuitry 143 and potentially other components and/or functionality. The administrator device processing circuitry 143 may, for example, determine latency metrics for the network 113. Additionally, the administrator device processing circuitry 143 may be operable to generate messages indicating that the latency of the network 113 is abnormal. Furthermore, the administrator device processing circuitry 143 may be operable to adjust the configuration of the network 113 responsive to an abnormal latency. In alternative embodiments, the functionality of monitoring and/or controlling attributes of the network 113 may be performed by the source device 103, the destination device 106, and/or other devices.

The destination device 106 is representative of multiple destination devices 106 that may be in communication with the network 113. According to various embodiments, the destination device 106 may comprise a processor-based system, such as a server computer or any other suitable computing device. The destination device 106 is operable to receive data packets 126 from the network 113. To this end, the destination device 106 comprises destination device processing circuitry 146 and potentially other components and/or functionality. The destination device processing circuitry 146 may, for example, receive a data packet 126, remove the control data and timestamp data in the data packet 126, and process the payload data in the data packet 126. As such, the destination device processing circuitry 146 may comprise, for example, a network interface card (NIC) and/or other types of components.

According to various embodiments, the source device 103, the destination device 106, the ingress switch 116, the transit switch 119, the egress switch 123, and/or other devices associated with the network 113 are synchronized using a timing protocol. By being synchronized using a timing protocol, the devices may operate with respect to a common time reference. As non-limiting examples, the 1588 Precision Time Protocol (PTP) or the 1588 Network Time Protocol (NTP) may be used as a timing protocol to synchronize two or more of the network devices.

Next, a discussion of an example of the operation of the networked environment 100 is provided. In the following discussion, it is assumed that the source device 103 and the destination device 106 are powered and in communication with the network 113.

The source device 103 may prepare to transmit a data packet 126 that comprises body data that is to be transmitted as at least a portion of the payload. Such body data may be generated by and originate from the source device 103. Alternatively, another device may generate the body data, and the source device 103 may receive the body data from the other device and then transmit the body data in the data packet 126 on behalf of the other device.

The source device 103 may also provide the outgoing data packet 126 with timestamp data. The timestamp data may comprise, for example, the time when the source device transmitted the data packet 126, an identifier that identifies the source device 103, and/or potentially other information. To provide the data packet 126 with the timestamp information, the source device processing circuitry 129 may insert one or more fields into the data packet 126. For example, in various embodiments, the source device processing circuitry 129 inserts one or more fields into the header portion, the payload portion, and/or the footer portion of the data packet 126.

According to various embodiments, the source device processing circuitry 129 may provide the data packet 126 with a timestamp field that is designated for data representing the time when the source device 103 transmitted a data packet 126. Alternatively, the source device processing circuitry 129 may provide the data packet 126 with a timestamp field that is designated for data representing the time when the ingress switch 116 processed the data packet 126. The time when the ingress switch 116 processed the data packet 126 may be, for example, the time when the ingress switch 116 received or transmitted the data packet 126.

In alternative embodiments, the source device processing circuitry 129 provides the data packet 126 with multiple timestamp fields designated for data for multiple timestamps. For example, a first timestamp field may be designated for data representing the time when the source device 103 transmitted the data packet 126, and a second field may be designated for data representing the time the data packet 126 was processed by another network device, such as the ingress switch 116, the egress switch 123, the destination device 106, or any other device. According to various embodiments, the source device processing circuitry 129 may provide the data packet 126 with a predetermined number of timestamp fields, wherein each timestamp field is designated for the time when a respective device processed the data packet 126.

The source device processing circuitry 129 may also provide the data packet 126 with one or more device identifier fields. Each device identifier field is designated for data that identifies the network device that provided the timestamp data in a corresponding timestamp field. For example, if the source device 103 provides the data packet 126 with n timestamp fields, the source device 103 may also provide the data packet 126 with n device identification fields designated for data identifying the respective network device that provided the data in the corresponding timestamp field. In alternative embodiments, a data packet 126 may be transmitted without designated device identification fields, and device identification data may be added to a timestamp field along with the timestamp data. For instance, the source device processing circuitry 129 may provide a timestamp field with data that represents the time the source device 103 transmitted the data packet 126 and with data that identifies the source device 103.

Additionally, the source device processing circuitry 129 provides the payload protocol field in the data packet 126 with data indicating that the payload comprises timestamp data. For example, the source device processing circuitry 129 may provide the payload protocol field with data that the ingress switch 116 recognizes as indicating that the payload of the data packet 126 comprises timestamp data.

The source device processing circuitry 129 may also provide the payload portion of the data packet 126 with a timestamp format field. Such a timestamp format field may be designated for data that specifies the format used to express the time data provided in one or more timestamp fields. For example, a first value in the timestamp format field may specify that the time data in the one or more timestamp fields is expressed using the 1588 PTP format, and a second value in the timestamp format field may specify that the time data is expressed using the NTP format. Additionally, the timestamp format field may be designated for data that indicates the length of the data that is provided in the one or more timestamp fields.

The source device processing circuitry 129 may also provide the payload portion of the data packet 126 with a body data protocol field. Such a body data protocol field is designated for data indicating the format used for the body data within the payload of the data packet 126. For example, the data in the body data protocol field may identify that the body data uses the Internet Protocol version 4 (IPv4) protocol or any other type of available protocol.

Additionally, the source device processing circuitry 129 may provide the data packet 126 with various other types of fields. For example, the data packet 126 may be provided with a destination address field, a source address field, VLAN tag fields, a body data field, a FCS field, and/or any other type of field. Thus, in various embodiments a data packet 126 may be generated that comprises a destination address field, a source address field, an outer VLAN tag field, an inner VLAN tag field, a payload protocol field, a payload format field, one or more timestamp fields, a body data protocol field, a body data field, a FCS field, and/or possibly other fields.

The source device processing circuitry 129 then populates the various fields with appropriate data. For example, the source device processing circuitry 129 generates data that represents the current time and provides the data to the first timestamp field. The destination address field is also populated with data identifying the destination device 106, and the source address field is populated with data identifying the source device 103. Additionally, the body data field is populated with the body data, and the body data protocol field is populated with data identifying the protocol used by the body data. The other fields in the data packet 126 are populated with corresponding data, as may be appreciated. With the fields populated with the appropriate data, the data packet 126 is then transmitted to the network 113.

After the data packet 126 is transmitted by the source device 103, the data packet 126 is received by the ingress switch 116. Upon the ingress switch 116 receiving the data packet 126, the ingress switch processing circuitry 133 identifies whether the data packet 126 comprises timestamp data. To this end, the ingress switch processing circuitry 133 may obtain the data in the payload protocol field and identify whether the data indicates that the payload uses a timestamp protocol.

If the data packet 126 is not using a timestamp protocol, the ingress switch processing circuitry 133 may modify the data packet 126 so that it comprises timestamp data. To this end, the ingress switch processing circuitry 133 may provide the data packet 126 with one or more of the fields discussed above. For example, the ingress switch processing circuitry 133 may provide the data packet 126 with one or more timestamp fields, a body data protocol field, a body data field, and potentially other fields.

The ingress switch processing circuitry 133 may then provide the various fields in the data packet 126 with the appropriate data. For example, the first timestamp field may be provided with data representing the time when the ingress switch 116 processed the data packet 126. The time when the ingress switch 116 processed the data packet 126 may be, for example, the time the ingress switch 116 received or transmitted the data packet 126. The ingress switch processing circuitry 133 may also provide the payload protocol field and the payload format field with data identifying that the payload comprises timestamp data and the format of the timestamp data, respectively. Additionally, the ingress switch processing circuitry 133 may obtain the original data from the payload protocol field of the received data packet 126 and provide this data to the body data protocol field. Furthermore, the original payload data in the received data packet 126 may be provided to the body data field of the data packet 126. Thereafter, the ingress switch 116 transmits the data packet 126 to the transit switch 119. Thus, if the ingress switch 116 receives a data packet 126 that lacks timestamp data, the ingress switch 116 may provide the data packet 126 with timestamp data, such as data representing the time when data packet 126 was processed by the ingress switch 116.

If the ingress switch 116 receives a data packet 126 that already comprises timestamp data, the ingress switch processing circuitry 133 may route and forward the data packet 126 comprising the timestamp data to the transit switch 119. In alternative embodiments, the ingress switch processing circuitry 133 provides the payload portion of the data packet 126 with data representing the time when the data packet 126 was processed by the ingress switch 116. Thus, if the source device 103 or another network device provided the data packet 126 with a timestamp field for the ingress switch 116, the ingress switch processing circuitry 133 provides the timestamp field with data representing the time when the ingress switch 116 processed the data packet 126. If there is not a pre-existing timestamp field for the ingress switch 116, the ingress switch processing circuitry 133 may provide the data packet 126 with an additional timestamp field and provide the additional timestamp field the data representing the time when the ingress switch 116 processed the data packet 126.

Thereafter, the ingress switch 116 provides the data packet 126 to the transit switch 119. Thus, if a received data packet 126 is using a timestamp protocol, the ingress switch 116 may provide the data packet 126 with data representing the time when the ingress switch 116 processed the data packet 126. In alternative embodiments, the ingress switch 116 routes and forwards the data packet 126 to the transit switch 119 without providing the data packet 126 with additional timestamp data.

After the data packet 126 is transmitted by the ingress switch 116, the transit switch 119 receives the data packet 126. Upon the transit switch 119 receiving the data packet 126, the transit switch processing circuitry 136 in various embodiments routes and forwards the data packet 126 with the timestamp data to the egress switch 123.

In alternative embodiments, the transit switch processing circuitry 136 provides the data packet 126 with data representing the time when the transit switch 119 processed the data packet 126. The time when the transit switch 119 processed the data packet 126 may be, for example, the time when the data packet 126 was received or transmitted by the transit switch 119.

If the received data packet 126 comprises a preexisting timestamp field designated for data representing the time when the transit switch 119 processed the data packet 126, the transit switch processing circuitry 136 may provide the preexisting timestamp field with data representing the time when the transit switch 119 processed the data packet 126. In alternative embodiments, the transit switch processing circuitry 136 may overwrite the data in a preexisting timestamp field. In further alternative embodiments, the transit switch processing circuitry 136 may provide the data packet 126 with an additional timestamp field and provide the additional timestamp field with data representing the time when the transit switch 119 processed the data packet 126.

Thereafter, the transit switch processing circuitry 136 transmits the data packet 126 to the egress switch 123. Thus, according to various embodiments, the transit switch 119 transmits the data packet 126 with or without timestamp data to the egress switch 123.

After the transit switch 119 transmits the data packet 126, the egress switch 123 receives the data packet 126. Upon the egress switch 123 receiving the data packet 126, the egress switch processing circuitry 139 in various embodiments routes and forwards the data packet 126 with the timestamp data to the destination device 106.

In alternative embodiments, the egress switch processing circuitry 139 provides the data packet 126 with data representing the time when the egress switch 123 processed the data packet 126. The time when the egress switch 123 processed the data packet 126 may be, for example, the time when the data packet 126 was received or transmitted by the egress switch 123.

If the received data packet 126 comprises a preexisting timestamp field designated for data representing the time when the egress switch 123 processed the data packet 126, the egress switch processing circuitry 139 may provide the preexisting timestamp field with data representing the time when the egress switch 123 processed the data packet 126. In alternative embodiments, the egress switch processing circuitry 139 overwrites the data in a preexisting timestamp field. In further alternative embodiments, the egress switch processing circuitry 139 may provide the data packet 126 with an additional timestamp field and provide the additional timestamp field with data representing the time when the egress switch 123 processed the data packet 126. Thereafter, the egress switch processing circuitry 139 transmits the data packet 126 to the destination device 106. Thus, according to various embodiments, the egress switch 123 may transmit the data packet 126 with or without timestamp data to the destination device 106.

After the egress switch 123 transmits the data packet 126, the destination device 106 receives the data packet 126. Upon the destination device 106 receiving the data packet 126, the destination device processing circuitry 146 in various embodiments removes various fields and the corresponding data from the data packet 126. For example, the destination device processing circuitry 146 may remove the timestamp format field, one or more timestamp fields, the body data protocol field, and/or potentially other fields. The destination device processing circuitry 146 also transmits the data in two or more of the timestamp fields to the administrator device 109.

In alternative embodiments, the destination device processing circuitry 146 provides the data packet 126 with data representing the time when the destination device 106 processed the data packet 126. The time when the destination device 106 processed the data packet 126 may be, for example, the time when the data packet 126 was received by the destination device 106.

If the received data packet 126 comprises a preexisting timestamp field designated for data representing the time when the destination device 106 processed the data packet 126, the destination device processing circuitry 146 provides the preexisting timestamp field with data representing the time when the destination device 106 processed the data packet 126. In alternative embodiments, the destination device processing circuitry 146 may overwrite the data in a preexisting timestamp field. In further alternative embodiments, the destination device processing circuitry 146 provides the data packet 126 with an additional timestamp field and provides the additional timestamp field with data representing the time when the destination device 106 processed the data packet 126.

Thereafter, the destination device processing circuitry 146 removes the timestamp format field, the one or more timestamp fields, the body data protocol field, and/or potentially other fields. Additionally, the destination device processing circuitry 146 may obtain the body data from the body data field. The body data may then be stored or further processed, for example. The destination device processing circuitry 146 also transmits the data in two or more of the timestamp fields to the administrator device 109.

After the destination device 106 transmits the timestamp data from two or more of the timestamp fields, the administrator device 109 receives the data. The administrator device processing circuitry 143 then subtracts the time represented in a first one of the timestamp data fields from the time represented in the second one of the timestamp data fields. The result from this subtraction represents the approximate one-way trip time for the data packet 126 between two corresponding network devices. For example, if the administrator device 109 subtracts the time provided by the destination device 106 from the time provided by the source device 103, the administrator device 109 identifies the approximate time it took for the data packet 126 to transmit from the source device 103 to the destination device 106. Accordingly, using the data provided by any two network devices in the networked environment 100, the administrator device can identify the time it took for the data packet 126 to transmit between the two network devices. Thus, the administrator device processing circuitry 143 identifies the one-way latency for a data packet 126 with respect to two or more of the network devices in the networked environment 100.

Additionally, the administrator device 109 may have access to data that represents the expected one-way latency with respect to two or more of the network devices in the networked environment 100. For example, a user may provide the administrator device 109 with the data representing the expected latencies. In alternative embodiments, the administrator device 109 may calculate and collect data representing the actual latencies using the process described above. The administrator device processing circuitry 143 may then determine the expected latency with respect to two or more of the network devices using the collected data. For example, an expected latency may be the average value of several actual latencies that are collected over a period of time.

The administrator device processing circuitry 143 may compare the actual latencies that are identified using the process described above with the expected latencies. If an actual latency exceeds the expected latency by a predetermined amount, the administrator device processing circuitry 143 may generate an alert. Such an alert may be, for example, a message that is stored in a log or that is transmitted to a user.

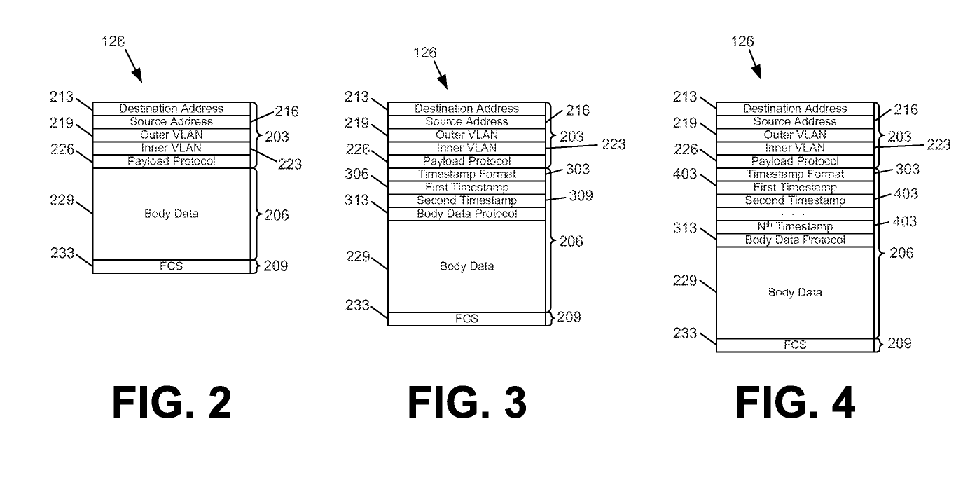

With reference to FIG. 2, shown is drawing representing a first example of a data packet 126 according to various embodiments of the present disclosure. In particular, the data packet 126 shown in FIG. 2 lacks timestamp data. Such a data packet 126 may, for example, be received by the ingress switch 116 (FIG. 1) according to various embodiments of the present disclosure.

The data packet 126 shown in FIG. 2 comprises a header 203, a payload 206, and a footer 209. The header 203 includes a destination address field 213, a source address field 216, an outer VLAN tag field 219, an inner VLAN tag field 223, and a payload protocol field 226. The payload 206 in the embodiment shown in FIG. 2 comprises a body data field 229, and the footer 209 comprises an FCS field 233. The payload protocol field 226 in the embodiment shown in FIG. 2 comprises data that represents the protocol being used by payload 206 and thus the body data in the body data field 229. For example, the payload protocol field 226 may comprise data indicating that the body data uses the IPv4 data protocol.

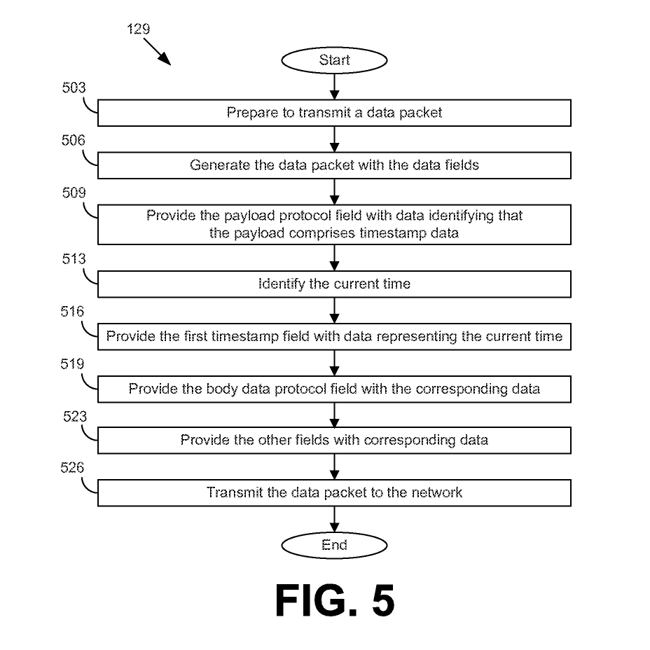

With reference to FIG. 3, shown is a drawing representing a second example of a data packet 126 according to various embodiments of the present disclosure. In particular, the data packet 126 shown in FIG. 3 may be generated, for example, by the source device 103 (FIG. 1) or the ingress switch 116 (FIG. 1).

The data packet 126 in the embodiment shown in FIG. 3 comprises the header 203, the payload 206, and the footer 209. The header 203 further includes the destination address field 213, the source address field 216, the outer VLAN tag field 219, the inner VLAN tag field 223, and the payload protocol field 226. In the embodiment shown in FIG. 3, the payload protocol field 226 comprises data indicating that the payload 206 of the data packet 126 comprises timestamp data.

The payload 206 further comprises a timestamp format field 303, a first timestamp field 306, a second timestamp field 309, a body data protocol field 313, and the body data field 229. In the embodiment shown in FIG. 3, the body data protocol field 313 comprises data that represents the protocol being used by the body data in the body data field 229. For example, the data in the body data protocol field 313 may identify that the body data uses the IPv4 protocol.

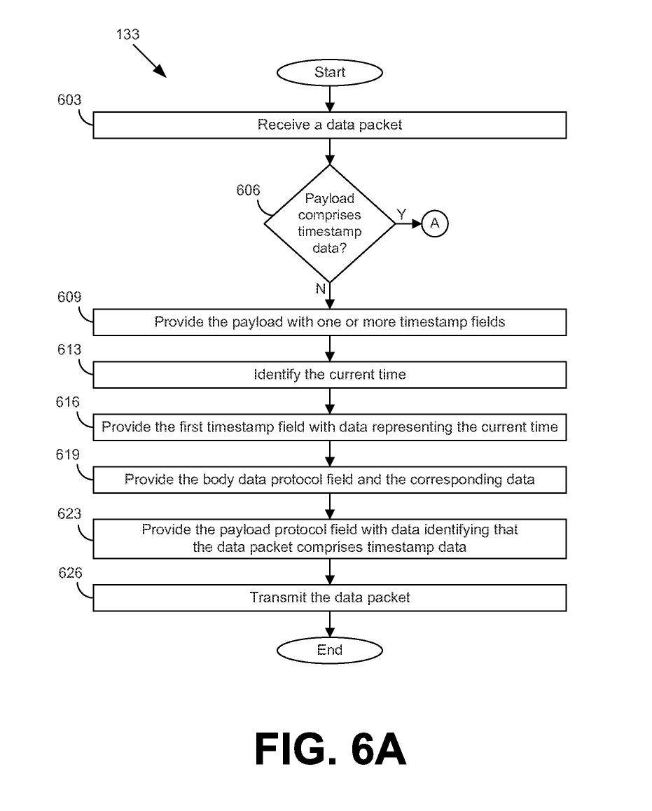

With reference to FIG. 4, shown is a third example of a data packet 126 according to various embodiments of the present disclosure. In particular, the data packet 126 shown in FIG. 4 may be generated, for example, by the source device 103 (FIG. 1) or the ingress switch 116 (FIG. 1).

The data packet 126 shown in FIG. 4 comprises the header 203, the payload 206, and the footer 209. The header 203 includes the destination address field 213, the source address field 216, the outer VLAN tag field 219, the inner VLAN tag field 223, and the payload protocol field 226. The payload protocol field 226 in the embodiment shown in FIG. 4 comprises data indicating that the payload 206 comprises timestamp data.

The payload 206 comprises the timestamp format field 303, multiple timestamp fields 403, the body data protocol field 313, and the body data field 229. The timestamp format field 303 comprises data identifying the particular format of the timestamp data. Additionally, the timestamp format field 303 may comprise data identifying the length of the timestamp data. The body data protocol field 313 comprises data that represents the protocol being used by the body data in the body data field 229. For example, the data in the body data protocol field 313 may identify that the data in the body data field 229 uses the IPv4 protocol.

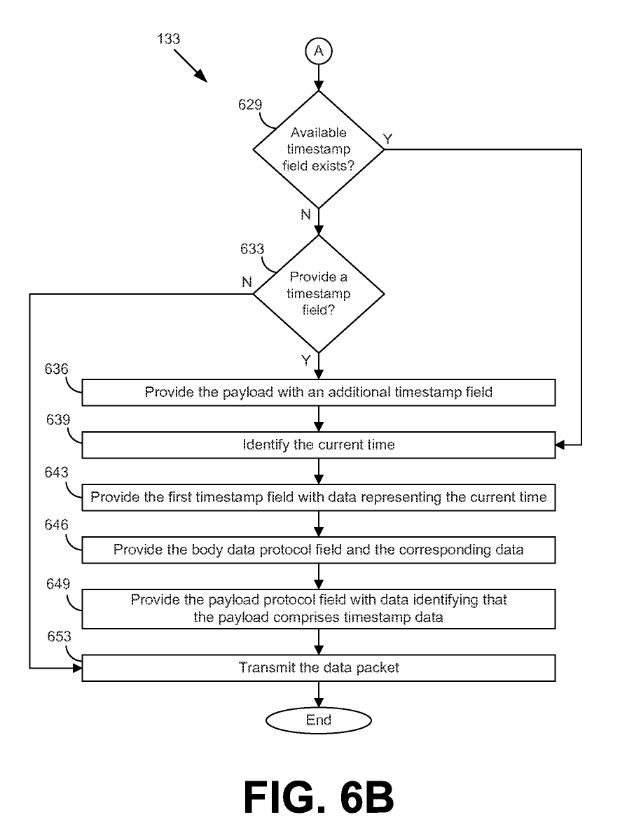

With reference to FIG. 5, shown is a flowchart illustrating an example of at least a portion of the functionality implemented by the source device processing circuitry 129 according to various embodiments of the present disclosure. In particular, the flowchart of FIG. 5 illustrates an example of the source device processing circuitry 129 generating and transmitting a data packet 126 (FIG. 1) that comprises timestamp data. It is understood that the flowchart of FIG. 5 provides merely an example of the many different types of functionality that may be implemented by the source device processing circuitry 129 as described herein. Additionally, the flowchart of FIG. 5 may be viewed as depicting an example of steps of a method implemented in the source device 103 (FIG. 1) according to one or more embodiments.

Beginning at reference number 503, the source device processing circuitry 129 prepares to transmit a data packet 126. As indicated at reference number 506, the data packet 126 is generated with various data fields. For example, the data packet 126 may comprise a destination address field 213 (FIG. 3), a source address field 216 (FIG. 3), an outer VLAN tag field 219 (FIG. 3), an inner VLAN tag field 223 (FIG. 3), a payload protocol field 226 (FIG. 3), a timestamp format field 303 (FIG. 3), a first timestamp field 306 (FIG. 3), a second timestamp field 309 (FIG. 3), a body data protocol field 313 (FIG. 3), a body data field 229 (FIG. 3), an FCS field 233 (FIG. 3), and/or potentially other fields.

As shown at reference number 509, the payload protocol field 226 is provided with data that indicates that the payload 206 (FIG. 2) of the data packet 126 comprises timestamp data. The source device processing circuitry 129 then identifies the current time, as shown at reference number 513. As previously mentioned, the source device 103 may be synchronized with one or more other network devices using a timing protocol.

As represented at reference number 516, the first timestamp field 306 is provided with data representing the current time. The source device processing circuitry 129 then provides the body data protocol field 313 with data identifying the protocol that is used by the data in the body data field 229, as indicated at reference number 519. For example, the body data protocol field 313 may comprise data identifying that the body data uses the IPv4 protocol.

The source device processing circuitry 129 then provides the other generated fields with corresponding data, as shown at reference number 523. For example, the body data field 229 is provided with the body data. As indicated at reference number 526, the data packet 126 is then transmitted to the network 113 (FIG. 1). Thereafter, the process ends.

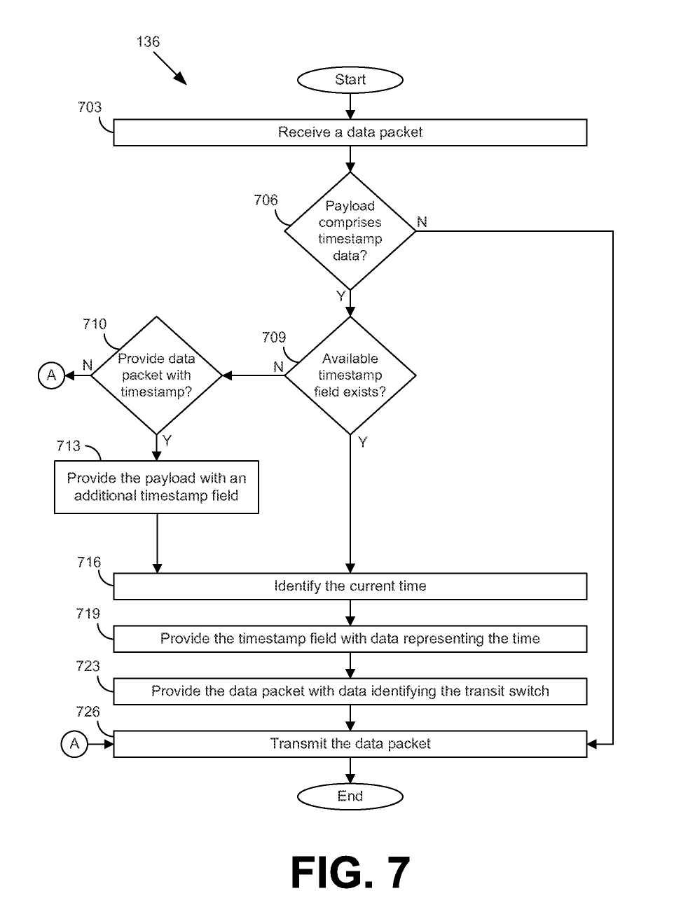

With reference to FIGS. 6A-6B, shown is a flowchart illustrating an example of at least a portion of the functionality implemented by the ingress switch processing circuitry 133 according to various embodiments of the present disclosure. In particular, the flowchart of FIGS. 6A-6B illustrates an example of the ingress switch processing circuitry 133 receiving and transmitting a data packet 126 (FIG. 1) that may comprise timestamp data. It is understood that the flowchart of FIG. 6 provides merely an example of the many different types of functionality that may be implemented by the ingress device processing circuitry 133 as described herein. Additionally, the flowchart of FIGS. 6A-6B may be viewed as depicting an example of steps of a method implemented in the ingress switch 116 (FIG. 1) according to one or more embodiments.

Beginning at reference number 603, the ingress switch processing circuitry 133 receives a data packet 126. The data packet 126 may have been transmitted by the source device 103 (FIG. 1) or by another device. As such, the data packet 126 may or may not comprise timestamp data.

At reference number 606, the ingress switch processing circuitry 133 identifies whether the payload 206 (FIG. 2) of the received data packet 126 comprises timestamp data. To this end, the ingress switch processing circuitry 133 may, for example, obtain the data in the payload protocol field 226 (FIG. 2) and identify whether the data indicates that the data packet 126 comprises timestamp data.

If the payload 206 of the received data packet 126 does not comprise timestamp data, the ingress switch processing circuitry 133 provides the payload 206 of the data packet 126 with one or more timestamp fields 403, as shown at reference number 609. As indicated at reference number 613, the ingress switch processing circuitry 133 identifies the current time. Then, as shown at reference number 616, the first timestamp field 403 is provided with data that represents the current time.

As shown at reference number 619, the ingress switch processing circuitry 133 then provides the payload 206 of the data packet 126 with the body data protocol field 313 (FIG. 3) and the data identifying the protocol used for the body data. For example, the data in the body data protocol field 313 may be the same as the data that was in the payload protocol field 226 when the data packet 126 was received by the ingress switch 116. As indicated at reference number 623, the payload protocol field 226 is then provided with data that identifies that the payload 206 of the data packet comprises timestamp data. The ingress switch processing circuitry 133 then transmits the data packet 126 to, for example, the transit switch 119 (FIG. 1), as shown at reference number 626.

As indicated at reference number 606, if it is identified that the payload 206 of the data packet 126 does comprise timestamp data, the ingress switch processing circuitry 133 identifies whether a preexisting timestamp field 403 is available for the ingress switch 116, as shown at reference number 629. In this regard, the ingress switch processing circuitry 133 may identify whether an “empty” timestamp field 403 exists and is available to contain data representing the time provided by the ingress switch 116. If a preexisting timestamp field 403 is not available, the ingress switch processing circuitry 133 identifies whether it should provide the payload 206 of the data packet 126 with another timestamp field 406, as shown at reference number 633. If an additional timestamp field 403 is not to be provided, the data packet is transmitted 126 to, for example, the transit switch 119. If the ingress switch processing circuitry 133 is to provide an additional timestamp field 403, as indicated at reference number 636, the payload 206 of the data packet 126 is provided with an additional timestamp field 403.

As shown at reference number 639, the ingress switch processing circuitry 133 then identifies the current time. Data representing the current time is then provided to the additional timestamp field 403, as indicated at reference number 643.

The body data protocol field 313 is then provided with data identifying the protocol used by the body data, as shown at reference number 646. As indicated at reference number 649, the payload protocol field 226 is then provided with data identifying that the payload 206 comprises timestamp data. The data packet 126 is then transmitted to, for example, the transit switch 119, as shown at reference number 653. Thereafter, the process ends.

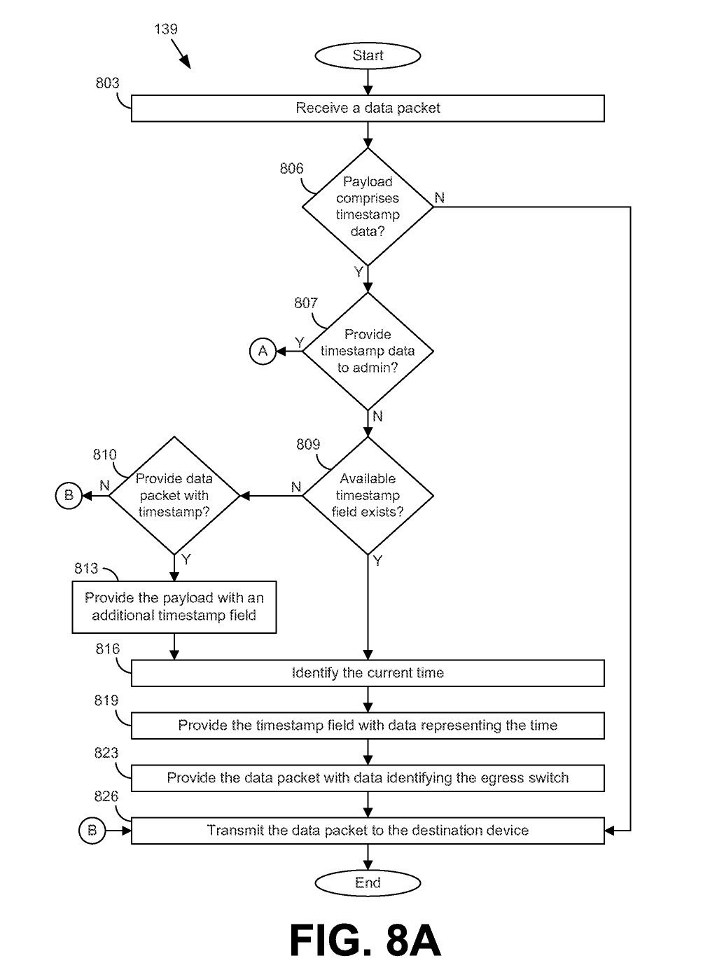

With reference to FIG. 7, shown is a flowchart illustrating an example of at least a portion of the functionality implemented by the transit switch processing circuitry 136 according to various embodiments of the present disclosure. In particular, the flowchart of FIG. 7 illustrates an example of the transit switch processing circuitry 136 receiving and transmitting a data packet 126 (FIG. 1) that may comprise timestamp data. It is understood that the flowchart of FIG. 7 provides merely an example of the many different types of functionality that may be implemented by the transit switch processing circuitry 136 as described herein. Additionally, the flowchart of FIG. 7 may be viewed as depicting an example of steps of a method implemented in the transit switch 119 (FIG. 1) according to one or more embodiments.

Beginning at reference number 703, the transit switch processing circuitry 136 receives a data packet 126. The data packet 126 may have been transmitted, for example, by the ingress switch 116 (FIG. 1). At reference number 706, the transit switch processing circuitry 136 identifies whether the payload 206 (FIG. 2) of the received data packet 126 comprises timestamp data. To this end, the transit switch processing circuitry 136 may, for example, obtain the data in the payload protocol field 226 (FIG. 2) and identify whether the data indicates that the payload 206 of the data packet 126 comprises timestamp data. If the payload 206 of the data packet 126 does not comprise timestamp data, the data packet 126 is transmitted to, for example, the egress switch 123 (FIG. 1).

As indicated at reference number 709, if the payload 206 of the received data packet 126 does comprise timestamp data, the transit switch processing circuitry 136 identifies whether there is a preexisting timestamp field 403 (FIG. 4) that is available for data representing the time when the transit switch 119 processed the data packet 126. If a preexisting timestamp field 403 is not available, the transit switch processing circuitry 136 identifies whether it is to provide the data packet 126 with timestamp data, as shown at reference number 710. If not, the transmit switch processing circuitry 136 proceeds to reference number 726, as shown. If the transit switch processing circuitry 136 is to provide the data packet 126 with timestamp data, the transit switch processing circuitry 136 provides the data packet 126 with an additional timestamp field 403, as indicated at reference number 713.

Next, the transit switch processing circuitry 136 identifies the current time, as shown at reference number 716, and provides the timestamp field 403 with the current time, as indicated at reference number 719. The data packet 126 is then provided with data that identifies the transit switch 119, as shown at reference number 723. The transit switch processing circuitry 136 then transmits the data packet 126 to, for example, the egress switch 123, as indicated at reference number 723. Thereafter, the process ends.

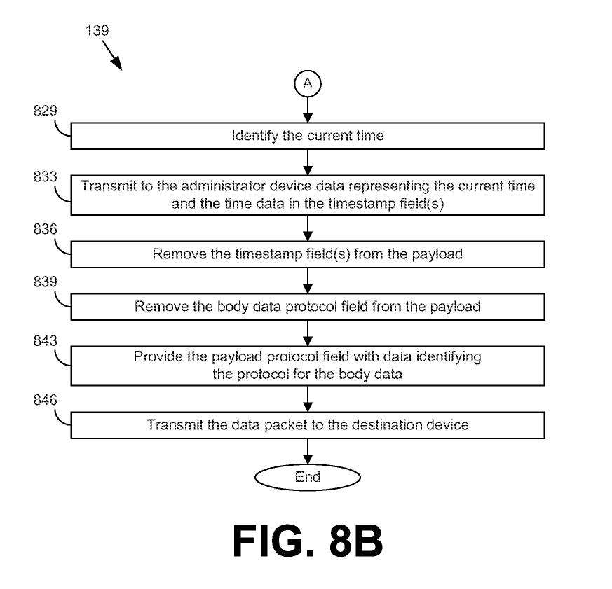

With reference to FIGS. 8A-8B, shown is a flowchart illustrating an example of at least a portion of the functionality implemented by the egress switch processing circuitry 139 according to various embodiments of the present disclosure. In particular, the flowchart of FIGS. 8A-8B illustrates an example of the egress switch processing circuitry 139 receiving and transmitting a data packet 126 (FIG. 1) that may comprise timestamp data. It is understood that the flowchart of FIGS. 8A-8B provides merely an example of the many different types of functionality that may be implemented by the egress switch processing circuitry 139 as described herein. Additionally, the flowchart of FIGS. 8A-8B may be viewed as depicting an example of steps of a method implemented in the egress switch 123 (FIG. 1) according to one or more embodiments.

Beginning at reference number 803, the egress switch processing circuitry 139 receives a data packet 126. The data packet 126 may have been transmitted, for example, by the transit switch 119 (FIG. 1). At reference number 806, the egress switch processing circuitry 139 identifies whether the payload 206 of the received data packet 126 comprises timestamp data. To this end, the egress switch processing circuitry 139 may, for example, obtain the data in the payload protocol field 226 (FIG. 2) and identify whether the data indicates that the payload 206 of the data packet 126 comprises timestamp data. If the payload 206 of the data packet 126 does not comprise timestamp data, the data packet 126 is transmitted to the destination device 106 (FIG. 1).

As indicated at reference number 807, if the payload 206 of the received data packet 126 does comprise timestamp data, the egress switch processing circuitry 139 identifies whether it is to provide the timestamp data to the administrator device 109 (FIG. 1). If so, the egress switch processing circuitry 139 moves to reference number 829. Otherwise, the egress switch processing circuitry 139 moves to reference number 809 and identifies whether there is a preexisting timestamp field 403 (FIG. 4) that is available for data representing the time when the egress switch 123 processed the data packet 126. If a preexisting timestamp field 403 is not available, the egress switch processing circuitry 139 identifies whether it is to provide the data packet 126 with timestamp data, as indicated at reference number 810. If not, the egress switch processing circuitry 139 moves to reference number 826 as shown. Otherwise, the egress switch processing circuitry 139 provides the data packet 126 with an additional timestamp field 403, as indicated at reference number 813.

Next, the egress switch processing circuitry 139 identifies the current time, as shown at reference number 816, and provides the timestamp field 403 with data representing the current time, as indicated at reference number 819. The data packet 126 is then provided with data that identifies the egress switch 123, as shown at reference number 823. As indicated at reference number 826, the egress switch processing circuitry 139 then transmits the data packet 126 to the destination device 106.

As indicated at reference number 829, the egress switch processing circuitry 139 identifies the current time. The egress switch processing circuitry 139 then transmits to the administrator device 109 data that represents the current time and the time data that is present in one or more of the timestamp fields 403 (FIG. 4) in the data packet 126, as shown at reference number 833.

Next, the one or more timestamp fields 403 are removed from the payload 206 (FIG. 2) of the data packet 126, as shown at reference number 836. Additionally, the body data protocol field 313 (FIG. 4) is removed from the payload 206 of the data packet 126, as indicated at reference number 839. As shown at reference number 843, the payload protocol field 226 (FIG. 4) is provided with data that identifies the protocol used for the data in the body data field 229 (FIG. 2). The data identifying the protocol used for the body data may be obtained from the body data protocol field 313 that may have been previously removed.

As shown at reference number 846, the data packet 126 is then transmitted to the destination device 106. Thereafter, the process ends.

In alternative embodiments, the egress switch processing circuitry 139 may identify the current time and obtain the time data that is present in one or more of the timestamp fields 403. Using this information, the egress switch processing circuitry 139 can identify the amount of time it took for the data packet 126 to be transmitted between two or more of the devices in the networked environment 100. If one or more of these times exceeds a predetermined threshold, the egress switch processing circuitry 139 may transmit a signal, such as a message, to the administrator device 109 or to another device to indicate that an abnormal network latency has been detected.

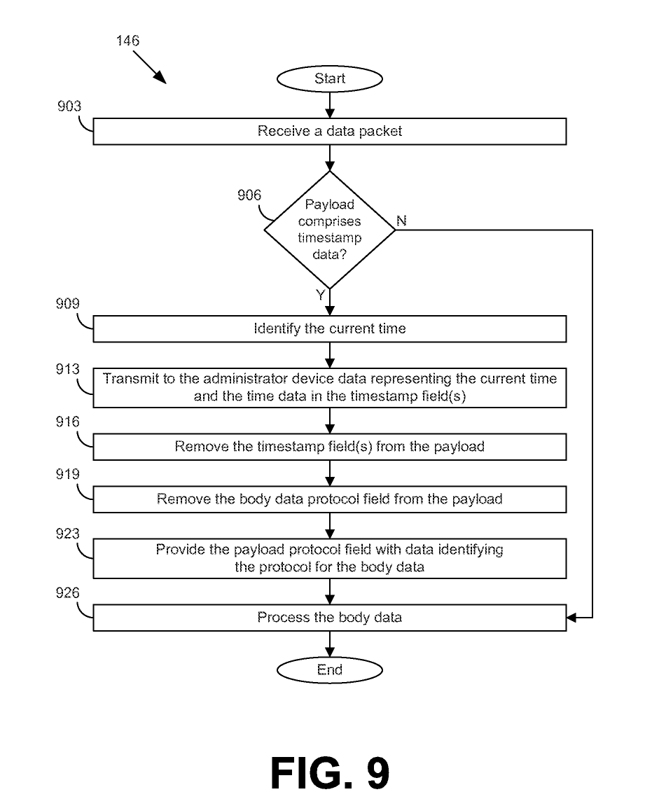

With reference to FIG. 9, shown is a flowchart illustrating an example of at least a portion of the functionality implemented by the destination device processing circuitry 146 according to various embodiments of the present disclosure. In particular, the flowchart of FIG. 9 illustrates an example of the destination device processing circuitry 146 receiving and processing a data packet 126 (FIG. 1) that may comprise timestamp data. It is understood that the flowchart of FIG. 9 provides merely an example of the many different types of functionality that may be implemented by the destination device processing circuitry 146 as described herein. Additionally, the flowchart of FIG. 9 may be viewed as depicting an example of steps of a method implemented in the destination device 106 (FIG. 1) according to one or more embodiments.

Beginning at reference number 903, the destination device processing circuitry 146 receives a data packet 126. The data packet 126 may have been transmitted by the egress switch 123 (FIG. 1), for example. As shown at reference number 906, the destination device processing circuitry 146 identifies whether the payload 206 (FIG. 2) of the received data packet 126 comprises timestamp data. To this end, the destination device processing circuitry 146 may obtain the data in the payload protocol field 226 and identify whether the data indicates that the payload 206 comprises timestamp data. If the payload 206 of the data packet 126 does not comprise timestamp data, the data in the body data field 229 (FIG. 2) is processed.

If the payload 206 of the data packet 126 does comprise timestamp data, the destination device processing circuitry 146 identifies the current time, as shown at reference number 909. The destination device processing circuitry 146 then transmits to the administrator device 109 data representing the current time and the time data from the one or more timestamp fields 403 (FIG. 4) in the data packet 126, as indicated at reference number 913.

Next, the one or more timestamp fields 403 are removed from the data packet 126, as shown at reference number 916. Additionally, the body data protocol field 313 is removed from the data packet 126, as indicated at reference number 919. As shown at reference number 923, the payload protocol field 226 (FIG. 2) is provided with data that identifies the protocol used for the data in the body data field 229 (FIG. 2). The data identifying the protocol used for the body data may be obtained from the body data protocol field 313 that may have been previously removed.

As shown at reference number 926, the body data from the body data field 229 is then processed. For example, the body data may be stored in the destination device 106 or provided to other components in the destination device 106 or another device. Thereafter, the process ends.

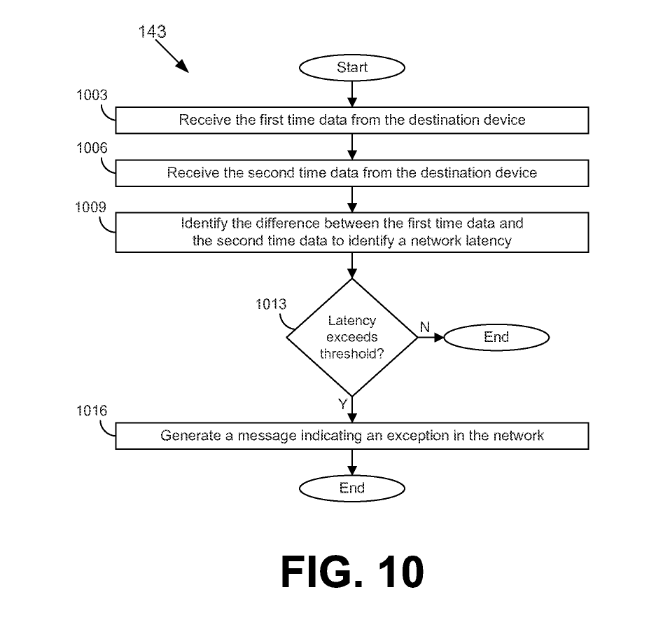

With reference to FIG. 10, shown is a flowchart illustrating an example of at least a portion of the functionality implemented by the administrator device processing circuitry 143 according to various embodiments of the present disclosure. In particular, the flowchart of FIG. 10 illustrates an example of the administrator device processing circuitry 143 identifying a network latency. It is understood that the flowchart of FIG. 10 provides merely an example of the many different types of functionality that may be implemented by the administrator device processing circuitry 143 as described herein. Additionally, the flowchart of FIG. 10 may be viewed as depicting an example of steps of a method implemented in the administrator device 109 (FIG. 1) according to one or more embodiments.

Beginning at reference number 1003, the administrator device processing circuitry 143 receives the first time data from the destination device 106 (FIG. 1). For example, the time data may represent the time when the source device 103 (FIG. 1) processed at data packet 126 (FIG. 1). As indicated at reference number 1006, the administrator device processing circuitry 143 receives second time data from the destination device 106. The second time data may represent, for example, the time when the destination device 106 processed the data packet 126.

As shown at reference number 1009, the difference between the time represented by the first time data and the time represented by the second time data is identified to determine the network latency for the data packet 126 traveling between the two corresponding network devices. The administrator device processing circuitry 143 then identifies whether the latency exceeds a predetermined threshold, as shown at reference number 1013. If the latency does not exceed the predetermined threshold, the process ends. Otherwise, the administrator device processing circuitry 143 generates a message indicating that an exception exists in the network 113 (FIG. 1), as shown at reference number 1016. Such a message may be, for example, stored in a log or transmitted to another device. Additionally, the message may include information identifying the particular network devices that correspond to the network latency. Thereafter the process ends. Additionally, the process may be repeated for the time data obtained from the other network devices.

Although the flowcharts of FIGS. 5, 6A-6B, and 7-10 show a specific order of execution, it is understood that the order of execution may differ from that which is depicted. For example, the order of execution of two or more items may be switched relative to the order shown. Also, two or more items shown in succession may be executed concurrently or with partial concurrence. Further, in some embodiments, one or more of the items shown may be skipped or omitted. Additionally, one or more items shown in one flow chart may be executed concurrently or partially concurrently with one or more items shown in another flowchart. In addition, any number of elements might be added to the logical flow described herein, for purposes of enhanced utility, accounting, performance measurement, providing troubleshooting aids, etc. It is understood that all such variations are within the scope of the present disclosure.

The components described herein may be implemented by circuitry. In this regard, such circuitry may be arranged to perform the various functionality described above by generating and/or responding to electrical or other types of signals. As used herein, circuitry may be general purpose hardware or hardware that is dedicated to performing particular functions. The circuitry may include, but is not limited to, discrete components, integrated circuits, or any combination of discrete components and integrated circuits. Such integrated circuits may include, but are not limited to, one or more microprocessors, system-on-chips, application specific integrated circuits, digital signal processors, microcomputers, central processing units, programmable logic devices, state machines, other types of devices, and/or any combination thereof. The circuitry may also include interconnects, such as lines, wires, traces, metallization layers, or any other element through which components may be coupled. Additionally, the circuitry may be configured to execute software to implement the functionality described herein.

Also, components and/or functionality described herein, including the source device processing circuitry 129 (FIG. 1), the ingress switch processing circuitry 133 (FIG. 1), the transit switch processing circuitry 136 (FIG. 1), the egress switch processing circuitry 139 (FIG. 1), the destination device processing circuitry 146 (FIG. 1), and/or the administrator device processing circuitry 143, can be embodied in any computer-readable medium, such as a non-transitory medium or a propagation medium, for use by or in connection with a system described herein. In this sense, the circuitry may comprise, for example, statements including instructions and declarations that can be fetched from the computer-readable medium and executed by the instruction execution system. In the context of the present disclosure, a “computer-readable medium” can be any medium that can propagate, contain, store, or maintain the logic, functionality, and/or application described herein.

The computer-readable medium can comprise any one of many physical media such as, for example, magnetic, optical, or semiconductor media. More specific examples of a suitable computer-readable medium may include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM), dynamic random access memory (DRAM), and/or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It is emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A method, comprising:
generating a data packet using at least one computing device, the data packet comprising:
a payload comprising:
a first timestamp field that comprises data indicating when a network device processed the data packet;
a body data field that comprises body data; and
a body data protocol field that comprises data identifying a protocol used by the body data; and
a header comprising a payload protocol field that comprises data identifying that the payload comprises timestamp data.

2. The method of claim 1, wherein the payload further comprises a second timestamp field that comprises data indicating when a second network device processed the data packet.

3. The method of claim 1, wherein the payload further comprises a device identification field that comprises data identifying the network device.

4. The method of claim 1, wherein the payload further comprises a timestamp format field that comprises data identifying a format for the data indicating when the network device processed the data packet.

5. A system, comprising:
a first network device comprising circuitry operable to:
provide a payload of a data packet with a timestamp field;
provide the timestamp field with first time data indicating when the first network device processed the data packet; and
a second network device comprising circuitry operable to:
receive the data packet with the first time data in the timestamp field;
obtain the first time data from the timestamp field; and
generate second time data indicating when the second network device processed the data packet; and
an administrator device comprising circuitry operable to:
receive the first time data and the second time data from the second network device; and
identify a network latency using the first time data and the second time data.

6. The system of claim 5, wherein the first network device comprises a network ingress switch.

7. The system of claim 5, wherein the first network device comprises a source device that is operable to transmit the data packet to a network in which the second network device operates.

8. The system of claim 5, wherein the circuitry in the second network device is further operable to:
remove the timestamp field from the data packet; and
process body data in the payload of the data packet.

9. The system of claim 5, wherein the circuitry in the second network device is further operable to:
provide the payload of the data packet with a second timestamp field; and
provide the second timestamp field with the second time data.

10. The system of claim 5, wherein the circuitry in the first network device is further operable to provide the payload of the data packet with a plurality of timestamp fields.

11. The system of claim 5, wherein the circuitry in the first network device is further operable to provide a payload protocol field in a header of the data packet with data that identifies that the payload of the data packet comprises timestamp data.

12. The system of claim 5, further comprising a transit switch comprising circuitry operable to:
receive the data packet with the timestamp field; and
provide the payload of the data packet with an additional timestamp field that comprises additional time data indicating when the transit switch processed the data packet.

13. The system of claim 5, wherein the circuitry in the first network device is further operable to:
provide the payload of the data packet with a body data field comprising body data; and
provide the payload of the data packet with a body data protocol field comprising data identifying a protocol used by the body data.

14. An apparatus, comprising:
a network device comprising circuitry operable to:
receive a data packet comprising a first timestamp field in a payload of the data packet, the first timestamp field comprising first time data indicating when another network device processed the data packet; and
provide a second timestamp field in the payload of the data packet with second time data indicating when the network device processed the data packet.

15. The apparatus of claim 14, wherein the circuitry is further operable to provide the payload of the data packet with the second timestamp field.

16. The apparatus of claim 14, wherein the circuitry is further operable to:
identify whether the second timestamp field exists in the payload of the data packet;
provide the payload of the data packet with the second timestamp field in response to the second timestamp field not existing in the payload.

17. The apparatus of claim 14, wherein the circuitry is further operable to:
identify whether a payload protocol field in a header of the data packet comprises data indicating that the payload comprises timestamp data; and
provide the second timestamp field in the payload of the data packet with second time data in response to the payload protocol field comprising data indicating that the payload comprises timestamp data.

18. The apparatus of claim 14, wherein the circuitry is further operable to provide the payload of the data packet with a device identifier identifying that the network device provided the second time data.

19. The apparatus of claim 14, wherein:
the network device comprises a network ingress switch; and
the circuitry is further operable to obtain the data packet from a source device that is external with respect to the network in which the network device operates.

20. The apparatus of claim 14, wherein the network device comprises a transit switch operable to transmit the data packet to at least one of an egress switch or another transit switch.
